(19) United States
(12) Patent Application Publication
(10) Pub. No.: US 2022/0130281 A1
(43) Pub. Date: Apr. 28, 2022

(54) ELECTRONIC DEVICE CONTROL METHOD AND ELECTRONIC DEVICE CONTROL SYSTEM APPLYING THE ELECTRONIC DEVICE CONTROL METHOD

(71) Applicant: PixArt Imaging Inc., Hsin-Chu City (TW)

(72) Inventors: Han-Lin Chiang, Hsin-Chu City (TW); Ning Shyu, Hsin-Chu City (TW); Guo-Zhen Wang, Hsin-Chu City (TW)

(73) Assignee: PixArt Imaging Inc., Hsin-Chu City (TW)

(21) Appl. No.: 17/571,510

(22) Filed: Jan. 9, 2022

Related U.S. Application Data
(63) Continuation-in-part of application No. 16/924,138, filed on Jul. 8, 2020.

(51) Int. Cl. G09B 29/00; B65F 1/14

(52) U.S. Cl. CPC G09B 29/003; B65F 1/14

(57) ABSTRACT

An electronic device control method, for calling a first electronic device in a building, comprising: (a) receiving a call command from an user by the first electronic device; (b) acquiring map information of the building by the first electronic device corresponding to the call command; and (c) driving the first electronic device to go to a user region in which the user is located according to the map information, wherein the user region is a predetermined region of a user location of the user.

### CROSS REFERENCE TO RELATED APPLICATIONS

This application is a continuation-in-part of applicant's earlier application, Ser. No. 16/924,138, filed Jul. 8, 2020 and is included herein by reference.

### BACKGROUND OF THE INVENTION

### 1. Field of the Invention

The present invention relates to an electronic device control method and an electronic device control system, and particularly relates to an electronic device control method and an electronic device control system which can call an electronic device to approach the user.

### 2. Description of the Prior Art

Trash cans are needed in each place. However, a user may need to walk for a long distance to reach a location of the trash can if too few trash cans are provided in a large building, since locations of the trash cans are fixed. On the opposite, if many trash cans are provided in a large building, many cleaning staffs are needed for cleaning the trashes, or the cleaning staffs need much time to clean the trashes. Also, if a user is handicapped, it is hard for him to go to a location of a trash can.

### SUMMARY OF THE INVENTION

One objective of the present invention is to provide an electronic device control method which can call a desired electronic device to a user.

Another objective of the present invention is to provide an electronic device control system which can call a desired electronic device to a user.

One embodiment of the present invention discloses an electronic device control method, for calling a first electronic device in a building, comprising: (a) receiving a call command from an user by the first electronic device; (b) acquiring map information of the building by the first electronic device corresponding to the call command; and (c) driving the first electronic device to go to a user region in which the user is located according to the map information, wherein the user region is a predetermined region of a user location of the user.

Another embodiment of the present invention discloses an electronic device control system, applied to a first electronic device in a building, comprising: a receiving interface, configured to receive a call command by an user; and a control circuit, configured to perform following steps: (a) acquiring map information of the building by the first electronic device corresponding to the call command; and (b) driving the first electronic device to go to a user region in which the user is located according to the map information, wherein the user region is a predetermined region of a user location of the user.

In view of above-mentioned embodiments, the user can call any needed electronic device to his/her location, thus the issues mentioned of prior art can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a trash can system according to one embodiment of the present invention.

FIG. 2 is a schematic diagram illustrating map information and how to determine the user location according to one embodiment of the present invention.

FIG. 3 is a schematic diagram illustrating a flow chart of a trash can system control method according to one embodiment of the present invention.

FIG. 4 is a schematic diagram illustrating map information sharing.

FIG. 5 is a schematic diagram illustrating an example of computing an available space of the trash can system according to one embodiment of the present invention.

FIG. 6 is a schematic diagram illustrating examples that the electronic device control method provided by the present invention is applied for other electronic devices.

FIG. 7 is a flowchart illustrating an electronic device control method according to one embodiment of the present invention.

### DETAILED DESCRIPTION

Several embodiments are provided in following descriptions to explain the concept of the present invention. Each component in following descriptions can be implemented by hardware (e.g. a device or a circuit) or hardware with software (e.g. a program installed to a processor). Besides, the method in following descriptions can be executed by programs stored in a non-transitory computer readable recording medium such as a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices.

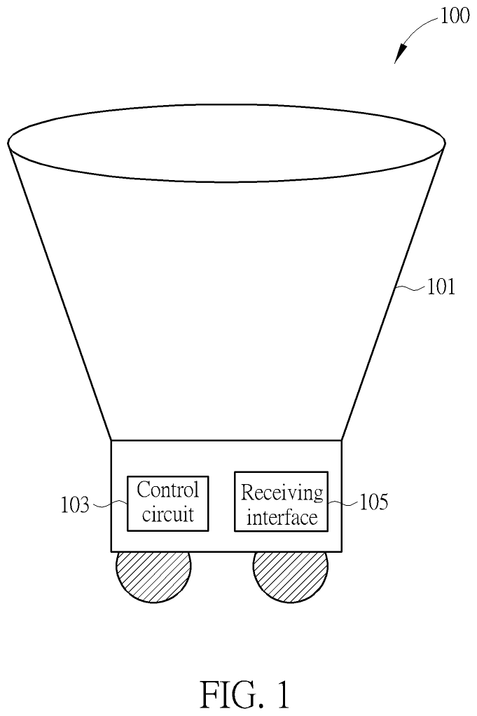

FIG. 1 is a schematic diagram illustrating a trash can system according to one embodiment of the present invention. As illustrated in FIG. 1, the trash can system 100 comprises a container 101, a control circuit 103, and a receiving interface 105. The container 101 is used to let users throw out trash (i.e., the container 101 can be a conventional trash can). The control circuit 103 is configured to control operations of the trash can system 100. The receiving interface 105 is configured to receive a call command by a user. The control circuit 103 is configured to perform the steps of: acquiring map information of the building, which the trash can system 100 is located in, corresponding to the call command; driving the trash can system 100 to go to a user region in which the user is located according to the map information, wherein the user region is a predetermined region of a user location of the user. In one embodiment, the predetermined region is 0, which means the user region is the user location.

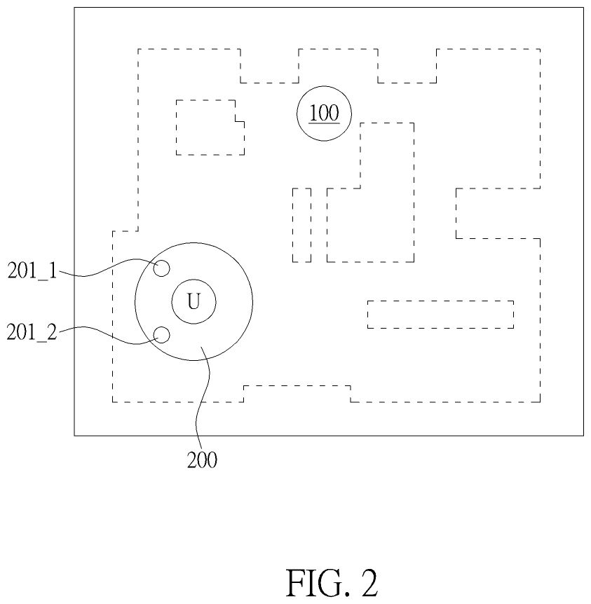

The map information can be generated via various conventional methods. For example, a conventional sweep robot can generate map information by laser or any other mechanism. FIG. 2 is a schematic diagram illustrating map information and how to determine the user location according to one embodiment of the present invention. As illustrated in FIG. 2, the map information is shown by dotted lines, which may comprise edges of a building. As above-mentioned, if the trash can system 100 receives a call command generated by the user U, the trash can system 100 goes to a user region 200 in which the user U is located according to the map information.

In one embodiment, the call command is one of following commands: a voice command, a command from a remote controller, and a command generated by an App (application program). If the call command is a voice command, the control circuit 103 controls the trash can system 100 to go to the user region 200 according to the map information and the voice command received by other device (s) in the user region 200. For example, as illustrated in FIG. 2, two sound receivers 201_1, 201_2 such as microphones are provided in the user region 200. Therefore, if the user U generates the voice command, the voice command is received by the sound receivers 201_1, 201_2, thereby the location of the user U can be determined by the locations of the sound receivers 201_1, 201_2. Please note, the sound receivers 201_1, 201_2 can be replaced by any other electronic device and a number thereof is not limited to two.

However, the location of the user U is not limited to be determined by sound received by two sound receivers. For example, if the call command is a command from a remote controller, or a command generated by the App, the call command can be transmitted via wireless communication such as WiFi or Bluetooth and the location of the user can be determined via the electronic devices for transmitting WiFi signals or Bluetooth signals. Also, the location of the user can also be determined via short distance signal devices such as RFIDs (Radio Frequency Identification)or NFCs (Near-field communication).

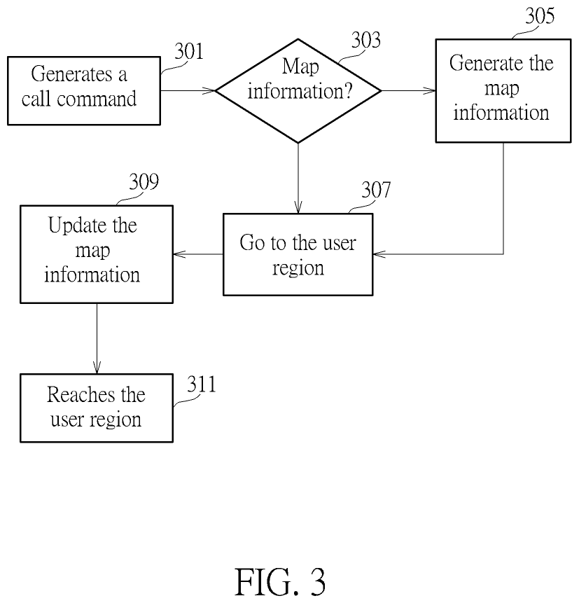

In one embodiment, the control circuit 103 reads the map information corresponding to the user region 200 from a storage device if the map information corresponding to the user region 200 is already recorded in the storage device. The storage device can be provided inside the trash can system 100 or provided outside the trash can system 100. If the map information corresponding to the user region is not recorded in the storage device, the control circuit 103 generates the map information corresponding to the user region. Such step is illustrated in FIG. 3, which is a schematic diagram illustrating a flow chart of a trash can system control method according to one embodiment of the present invention.

FIG. 3 comprises following steps:

Step 301

A user generates a call command for calling the trash can system.

Step 303

Determine whether the storage device stores map information near the user location (e.g., the map information of the user region), if yes, go to step 307, if not, go to step 305.

Step 305

Generate the map information corresponding to the user region.

Step 307

Go to the user region.

Step 309

Update the map information, if necessary.

Step 311

The trash can 100 reaches the user region.

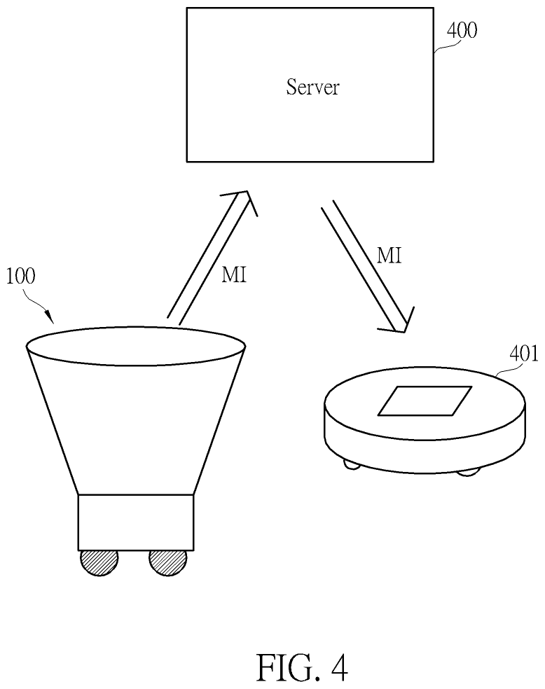

In one embodiment, the trash can system 100 can share the map information with at least one other electronic device. FIG. 4 is a schematic diagram illustrating map information sharing. As shown in FIG. 4, the trash can system 100 can transmit map information MI which it generates to a server 400. Then, a sweep robot 401 can read the map information MI from the server 400. On the opposite, the sweep robot 401 can transmit the map information MI which the sweep robot 401 generates to a server 401. Then, the trash can system 100 can read the map information MI from the server 400. In both ways, either the trash can system 100 or the sweep robot 401 can update the map information MI in the server 401 according collected information. Besides the map information MI, the user location can also be shared with other electronic device(s) following the same way.

In one embodiment, the trash can system 100 further comprises a capacity measurement system configured to measure an available capacity of the trash can system 100. Please note, the available capacity mentioned here can be a probable capacity such as much, medium or few rather than a precise value. The capacity measurement system can be implemented by various systems. For example, the capacity measurement system can measure the weight of the trash in the trash can system 100 to determine the available capacity.

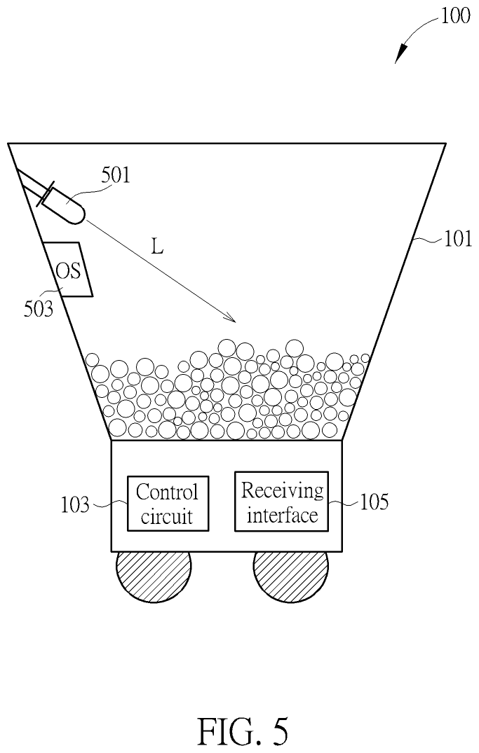

In one embodiment, the available capacity of the trash can system 100 is measured in an optical way. FIG. 5 is a schematic diagram illustrating an example of computing an available space of the trash can system according to one embodiment of the present invention. As illustrated in FIG. 5, the trash can system 100 further comprises a light source 501 and an optical sensor 503 (e.g., an image sensor) which are served as the capacity measurement system. The light source 501 is configured to emit light L to a bottom of the container 101 or a region near the bottom. Therefore, if much trash is inside the container 101, the optical sensor 503 receives much reflected light. On the opposite, if less trash is inside the container 101, the optical sensor 503 receives few reflected light. Therefore, the available capacity can be measured according to a light intensity of the reflected light received by the optical sensor 503.

Besides the above-mentioned functions, the trash can system 100 can further comprise other functions. In one embodiment, the trash can system 100 comprises a balance mechanism such that the trash can system 100 can be balanced when the container is empty or is filled with trash. In one embodiment, the trash can system 100 comprises a function of obstacle avoid mechanism. The obstacle avoid mechanism can be implemented by various ways. For example, the trash can system 100 can use VSLAM (Visual Simultaneous Localization And Mapping) to build map information comprising obstacle information, and can avoid the obstacle based on the map information. Also, the trash can system 100 can use light to detect the obstacle, such as laser or infrared, to detect the obstacle.

In one embodiment, the trash can system 100 further comprises a mechanism for determining a height of the obstacle, such that the trash can system 100 can determine if the trash can system 100 can directly go through the obstacle or the obstacle should be avoided. For example, U.S. application with an application Ser. No. 16/924,138, the present invention is a continuation-in-part thereof, discloses such mechanisms. Additionally, in one embodiment, the trash can system 100 comprises a trash compression mechanism to compress the trash in the container 101. Besides, in one embodiment, the trash can system 100 comprises a food waste treatment mechanism, to decrease a volume of the food waste.

In the embodiment of FIG. 1, the container 101 is a trash can. However, the container 101 can be replaced any other container. For example, the container 101 can be a shopping basket, such that the trash can system 100 can be changed to a shopping cart. For another example, the container 101 can be a storage box, such that the trash can system 100 can be changed to a storage system.

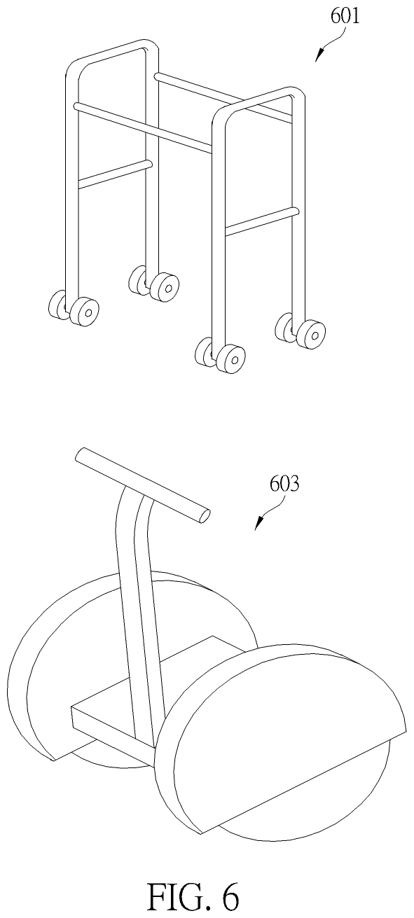

Besides a system comprising a container, the concepts disclosed in above-mentioned embodiments can be applied to any other electronic device which does not have a container. For example, as illustrated in FIG. 6, the concepts disclosed in above-mentioned embodiments can be applied a mobility aid 601, such as a walking aid or a wheel chair. Also, the concepts disclosed in above-mentioned embodiments can be applied an electronic vehicle 603 such as an electric skateboard, an electric bicycle or an electric baby carriage.

Therefore, in one embodiment, the control circuit 103 and the receiving interface 105 illustrated in FIG. 1, which forms an electronic device control system, can be provided in a control device. The control device can be easily removed from the trash can system 100 and installed to any other electronic device. In other words, different kinds of electronic device can share the same control device in a simple way.

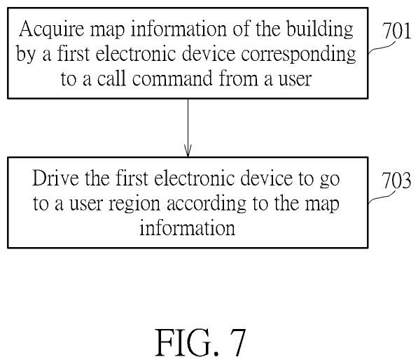

In view of above-mentioned embodiments, an electronic device control method can be acquired. FIG. 7 is a flow chart illustrating an electronic device control method according to one embodiment of the present invention, which is for calling a first electronic device in a building. In one embodiment, the electronic device control method is performed by the control circuit illustrated in FIG. 1 and comprises:

Step 701

Acquire map information of the building by a first electronic device corresponding to a call command from a user.

The first electronic device can be an electronic device comprises a container, such as the trash can system 100 illustrated in FIG. 1, or the above-mentioned shopping cart, the above-mentioned storage system. Also, the first electronic device can be the mobility aids or the electronic vehicle disclosed in FIG. 6.

Step 703

Drive the first electronic device to go to a user region (e.g., the user region 200 in FIG. 2) in which the user is located according to the map information, wherein the user region is a predetermined region of a user location of the user.

As above-mentioned, the first electronic device can share map information with a second electronic device, such as the sweep robot 401 illustrated in FIG. 4. Other detail contents are illustrated in above-mentioned embodiments, thus are omitted for brevity here.

In view of above-mentioned embodiments, the user can call any needed electronic device to his/her location, thus the issues mentioned of prior art can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device control method, for calling a first electronic device in a building, comprising:
(a) receiving a call command from an user by the first electronic device;
(b) acquiring map information of the building by the first electronic device corresponding to the call command; and
(c) driving the first electronic device to go to a user region in which the user is located according to the map information, wherein the user region is a predetermined region of a user location of the user.

2. The electronic device control method of claim 1, wherein the call command is one of following commands: a voice command, a command from a remote controller, and a command generated by an App (application program).

3. The electronic device control method of claim 2, wherein the call command is the voice command, wherein the step (c) controls the first electronic device to go to the user region according to the map information and the voice command received by another electronic device in the user region.

4. The electronic device control method of claim 1, wherein the step (b) reads the map information corresponding to the user region from a storage device if the map information corresponding to the user region is already recorded in the storage device, wherein the step (b) generates the map information corresponding to the user region if the map information corresponding to the user region is not recorded in the storage device.

5. The electronic device control method of claim 1, wherein the first electronic device shares the map information with a second electronic device.

6. The electronic device control method of claim 1, wherein in the first electronic device comprises a container.

7. The electronic device control method of claim 6, wherein the container is one of: a trash can, a shopping basket and a storage box.

8. The electronic device control method of claim 6, wherein the first electronic device further comprises a capacity measurement system configured to calculate an available capacity of the container.

9. The electronic device control method of claim 1, wherein in the first electronic device is a mobility aids or an electronic vehicle.

10. An electronic device control system, applied to a first electronic device in a building, comprising:
a receiving interface, configured to receive a call command by an user; and
a control circuit, configured to perform following steps:
(a) acquiring map information of the building by the first electronic device corresponding to the call command; and
(b) driving the first electronic device to go to a user region in which the user is located according to the map information, wherein the user region is a predetermined region of a user location of the user.

11. The electronic device control system of claim 10, wherein the call command is one of following commands: a voice command, a command from a remote controller, and a command generated by an App (application program).

12. The electronic device control system of claim 11, wherein the call command is the voice command, wherein the step (b) controls the first electronic device to go to the user region according to the map information and the voice command received by a second device in the user region.

13. The electronic device control system of claim 10, wherein the step (a) reads the map information corresponding to the user region from a storage device if the map information corresponding to the user region is already recorded in the storage device, wherein the step (a) generates the map information corresponding to the user region if the map information corresponding to the user region is not recorded in the storage device.

14. The electronic device control system of claim 10, wherein the first electronic device shares the map information with a second electronic device.

15. The electronic device control system of claim 10, wherein in the first electronic device comprises a container.

16. The electronic device control system of claim 15, wherein the container is one of: a trash can, a shopping basket and a storage box.

17. The electronic device control system of claim 15, wherein the first electronic device further comprises a capacity measurement system configured to calculate an available capacity of the container.

18. The electronic device control system of claim 10, wherein in the first electronic device is a mobility aids or an electronic vehicle.
